(19) United States
(12) Patent Application Publication
(10) Pub. No.: US 2011/0225377 A1
(43) Pub. Date: Sep. 15, 2011

(54) DATA STORAGE APPARATUS, DATA MANAGEMENT APPARATUS AND CONTROL METHOD THEREOF

(75) Inventor: Tatsuya OHMIDO, Kawasaki (JP)

(73) Assignee: FUJITSU LIMITED, Kawasaki (JP)

(21) Appl. No.: 13/026,765

(22) Filed: Feb. 14, 2011

(30) Foreign Application Priority Data
Mar. 12, 2010 (JP) 2010-056206

(51) Int. Cl. G06F 12/00

(52) U.S. Cl. 711/154; 711/E12.001

(57) ABSTRACT

A data storage apparatus, connected to an information processing apparatus, includes a library unit, a storage unit, and a control unit. The storage unit is configured to store a plurality of data including first and second data received from the information processing apparatus, and the control unit is configured to perform control, when performing processing to write the plurality of data from the storage unit to a recording medium in the library unit. If an update request for updating the second data specified to be written later than the first data is received from the information processing apparatus, the second data is written to the recording medium in the library unit before the first data is written.

### CROSS REFERENCE TO RELATED APPLICATION

This application is based upon and claims the benefit of priority of the prior Japanese Patent Application No. 2010-056206, filed on Mar. 12, 2010, the entire contents of which are incorporated herein by reference.

### FIELD

The embodiments discussed herein are related to a data storage apparatus, a data management apparatus and a control method thereof.

### BACKGROUND

A tape apparatus is known that stores large amounts of data by recording the data on tape media. The action that the tape apparatus performs when reading or writing data on a tape medium involves a mechanical action for mounting the tape medium onto a tape drive. This has caused an increase in waiting time on the side of the server that transmits the data to the tape apparatus during recording of the data on the tape medium.

The tape apparatus also performs a process called “export” to discharge the tape medium outside the tape apparatus. The export process is performed, for example, to transfer the data recorded on the tape medium to an external storage for such purposes as disaster recovery.

In the case of a related art tape apparatus, the export process has been performed by a business server reading data from a tape medium and copying the readout data to a tape medium for external storage. In this case, since the server's memory area having a limited capacity is used when performing the export, the tape apparatus has been unable to cache a plurality of logical volumes in the server and therefore unable to write a plurality of logical volumes collectively to the tape medium.

In view of this, there is proposed a virtual tape apparatus that performs tape management in a virtual manner on a storage other than the tape medium, for example, on a hard disk drive (EDD). In the virtual tape apparatus, tape image data is stored on the storage; here, because the storage does not involve any mechanical action such as tape mounting, the virtual tape apparatus offers fast data access compared with the real tape apparatus.

The virtual tape apparatus has a storage capable of storing a plurality of logical volumes, so that a plurality of logical volumes may be stored on the storage and then written collectively to a large-capacity tape medium.

Even in such a virtual tape apparatus, it takes time to write a plurality of logical volumes to a tape medium in the export process. Since the export process in the virtual tape apparatus, unlike the related tape apparatus, does not involve any data processing at the server side, the server does not monitor the condition of the export process. As a result, after issuing an export request to the virtual tape apparatus, it may happen that, during the export process, the server makes a write request to a logical volume to be exported.

If writing is made from the server to the logical volume being exported, an indeterminate logical volume in the process of being written may be written to the export destination tape medium. To prevent this, it has been the practice to perform logical volume exclusive control within the virtual tape apparatus so that, when an update request is received from the server, the export process is suspended or the update request is queued until the export process is completed.

However, there has been the problem that suspending the export process interferes with the scheduled operation of periodical data backup and queuing the update request in the server interferes with the normal operation of the server.

Patent Document 1: Japanese Laid-open Patent Publication No. 2007-293665

Patent Document 2: Japanese Laid-open Patent Publication No. 2005-267496

### SUMMARY

According to an aspect of the embodiment, a data storage apparatus, connected to an information processing apparatus, includes a library unit, a storage unit, and a control unit.

The storage unit is configured to store a plurality of data including first and second data received from the information processing apparatus, and the control unit is configured to perform control, when performing processing to write the plurality of data from the storage unit to a recording medium in the library unit.

If an update request for updating the second data specified to be written later than the first data is received from the information processing apparatus, the second data is written to the recording medium in the library unit before the first data is written.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1 is a diagram illustrating one configuration example of a system in which a data storage apparatus is used;

FIG. 2 is a diagram illustrating one configuration example of the data storage apparatus;

FIG. 3 is a diagram illustrating the hardware configuration of a data management unit;

FIG. 4 is a diagram illustrating the hardware configuration of a library unit;

FIG. 5 is a diagram for explaining one example of data stored on a storage unit;

FIG. 6 is a diagram illustrating one example of an export request and management information;

FIG. 7 is a diagram illustrating one example of a write-order control process;

FIG. 8 is a diagram illustrating one example of a sequence for data transmission between server and data storage apparatus;

FIG. 9 is a flowchart illustrating a first example of the write-order control; and

FIG. 10 is a flowchart illustrating a second example of the write-order control.

### DESCRIPTION OF EMBODIMENTS

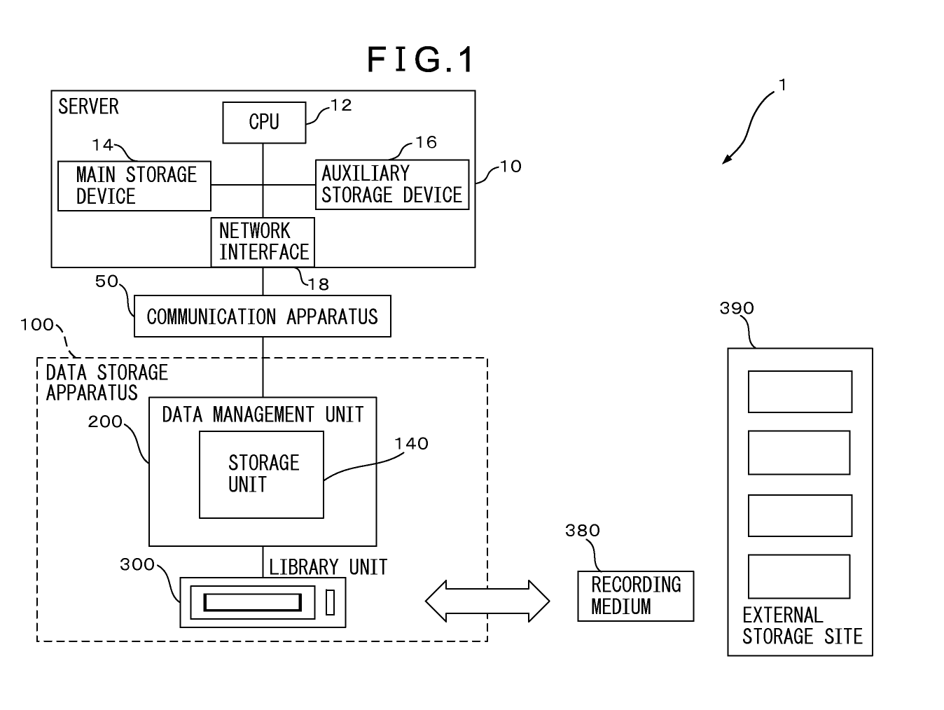

Preferred embodiments of a data storage apparatus will be described below with reference to the drawings.

[System configuration] FIG. 1 is a diagram illustrating one configuration example of a system in which a data storage apparatus 100 is used. The system 1 illustrated in FIG. 1 includes a server 10 and a communication apparatus 50 in addition to the data storage apparatus 100.

[System configuration: Data storage apparatus] The data storage apparatus 100 includes a data management unit 200 and a library unit 300. The server 10 and the data storage apparatus 100 are interconnected so that data may be transmitted between them. The server 10 and the data storage apparatus 100 are connected, for example, by a fiber optic cable. In FIG. 1, only one server 10 is illustrated for illustrative purposes, but the number of servers is not limited to that illustrated here.

In the data storage apparatus 100, the data management unit 200 includes a storage unit 140, and the library unit 300 accommodates a plurality of recording media. The storage unit 140 is a device that records data on a recording medium and that does not have the mounting/unmounting of the recording medium. The library unit 300 is a device that records data on a recording medium and that performs the mounting/unmounting of the recording medium. The storage unit 140 is, for example, a disk array device that records data on magnetic disks. The library unit 300 is, for example, a device that records data on magnetic tape by using a tape drive. The recording media here include magnetic tapes, magnetic disks, etc. The data storage apparatus 100 virtualizes the storage unit 140, enabling the server 10 to use the virtualized storage unit as the library unit 300.

In the data storage apparatus 100, data written to the data storage apparatus 100 from the server 10 are stored on the storage unit 140, and all the data to be accessed from the server 10 for reading are also stored on the storage unit 140. Accordingly, when the server 10 makes a request to write data to the recording medium mounted in the library unit 300, the server 10 sends the write data to the data storage apparatus 100, and the data management unit 200 writes the received data to the storage unit 140. On the other hand, when the server 10 makes a request to read data from the recording medium mounted in the library unit 300, the data storage apparatus 100 reads the requested data from the storage unit 140 and transfers it to the server. Since the storage unit 140 does not involve any mechanical action such as media mounting as performed in the library unit 300, the data storage apparatus 100 may quickly respond to the access request from the server 10 by accessing the storage unit 140, thus providing fast data access.

In FIG. 1, the data management unit 200 and the library unit 300 are illustrated as being contained in a single entity called the data storage apparatus 100, but they may be contained in different casings as physically separated units.

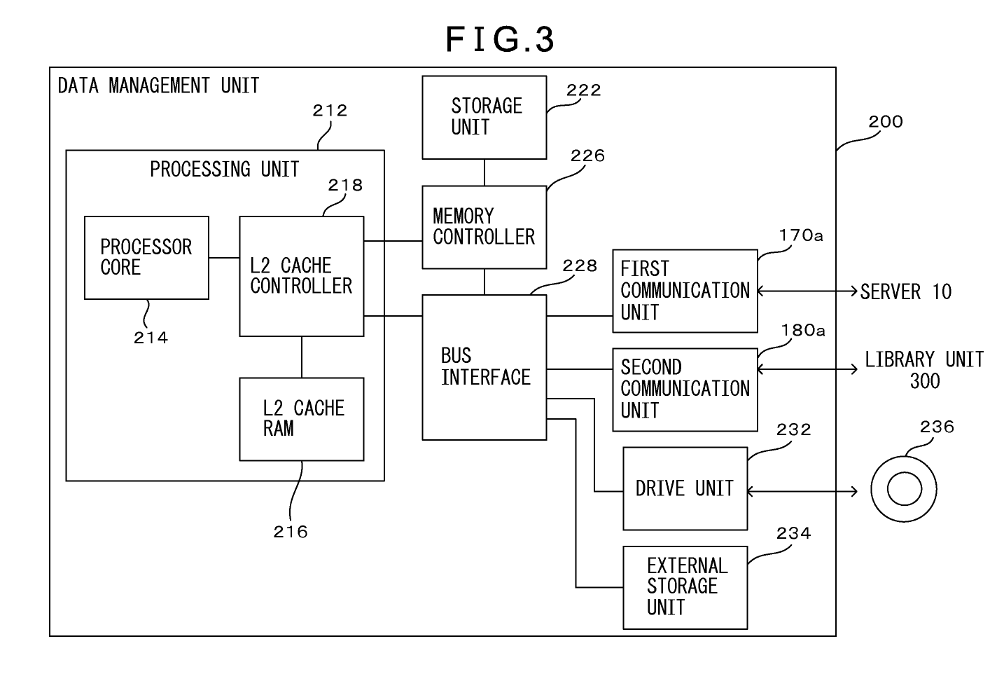

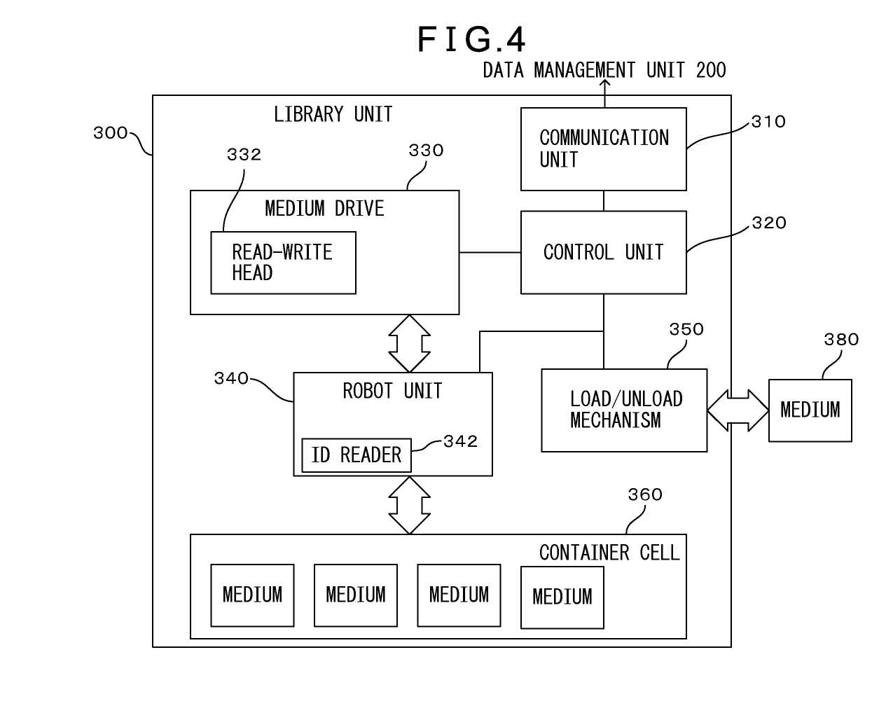

When an export request is received from the server 10, the data storage apparatus 100 performs an export process to transfer the data outside the data storage apparatus 100 by writing the requested data stored on the storage unit 140 to a recording medium 380 for external storage. The external recording medium 380 is stored, for example, in an external storage site 390. The data written to the external recording medium 380 may be transferred to the library 300 in the data storage apparatus 100 by loading the external recording medium 380 into the library 300 in the data storage apparatus 100. A further detailed description of the data storage apparatus 100 will be given later with reference to FIG. 3 and FIG. 4.

[System configuration: Server] The server 10 is an information processing apparatus which makes a data read/write request to the data storage apparatus 100. The server 10 includes a central processing unit (CPU) 12, a main storage device 14, an auxiliary storage device 16, and a network interface 18.

The CPU 12 implements the desired function by executing a program stored in the main storage device 14. For example, the CPU 12 performs a mathematical operation and stores the result of the operation in the auxiliary storage device 16. Further, the CPU 12 issues to the data storage apparatus 100 a request for writing data stored in the auxiliary storage device 16 to the data storage apparatus 100 or a request for reading data stored in the data storage apparatus 100 and writing it to the auxiliary storage device 16. Furthermore, the CPU 12 creates an export request and sends it to the data storage apparatus 100. The export request is created, for example, for the purpose of discharging batch processing results being output at nighttime to the outside of the data storage apparatus 100.

The CPU 12 identifies a plurality of disks defined as physical volumes, or a set of storage areas on the same disk, as being one logical volume. Accordingly, the CPU 12 identifies the data stored on the auxiliary storage device 16 as being logical volume data.

The main storage device 14 is a storage device that the CPU 12 may directly access to read or write data. The main storage device 14 is, for example, a dynamic random access memory (DRAM).

The auxiliary storage device 16 is a storage device that has a larger storage space than the main storage device 14 and that retains its stored contents after its power supply is removed. The auxiliary storage device 16 is, for example, a disk array comprising a collection of magnetic disks, or a solid-state drive (SSD) using a flash memory.

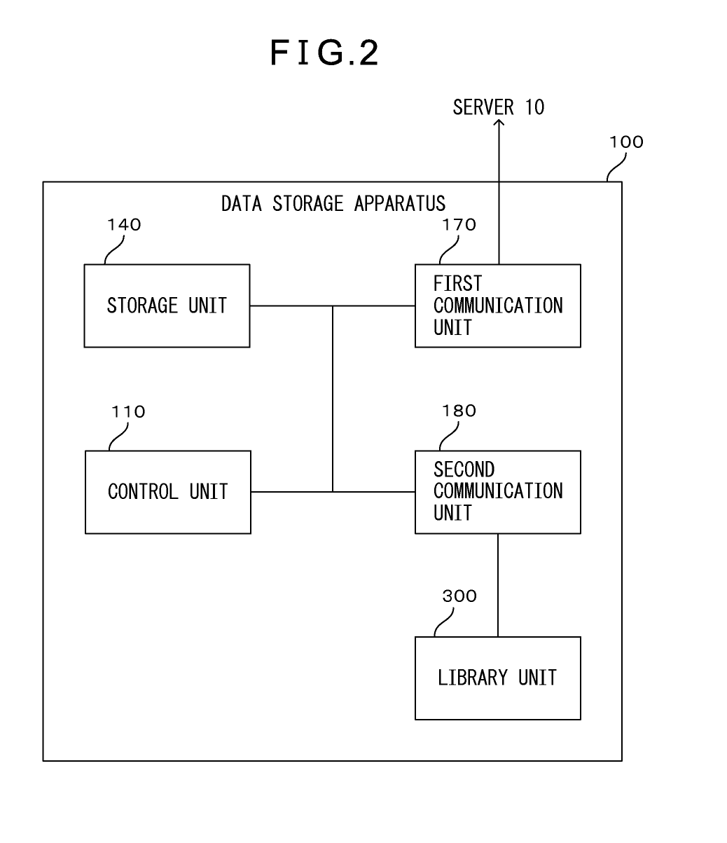

The network interface 18 is a circuit that is connected to the communication apparatus 50 by a cable such as a fiber optic cable to implement communication functions conforming, for example, to the Fiber Channel Standard, and is identified by its worldwide name (WWN).

[System configuration: Communication device] The communication apparatus 50 is a concentrator that provides data communications between the server 10 and the data storage apparatus 100. The communication apparatus 50 has a plurality of ports, and a fiber optic cable connecting to the server 10 is connected to one of the ports of the communication apparatus 50, while a fiber optic cable connecting to the data storage apparatus 100 is connected to another one of the ports of the communication apparatus 50. The communication apparatus 50 provides data communications between the server 10 and the data storage apparatus 100 by transferring data between the port to which the server 10 is connected and the port to which the data storage apparatus 100 is connected.

[Data storage apparatus] One example of the data storage apparatus will be described with reference to FIG. 2 to FIG. 7.

FIG. 2 is a diagram illustrating one configuration example of the data storage apparatus. The data storage apparatus 100 illustrated in FIG. 2 includes a control unit 110, a storage unit 140, a first communication unit 170, a second communication unit 180, and a library unit 300.

[Data storage apparatus: Communication units] The first communication unit 170 is connected to the server 10 via the communication apparatus 50. The second communication unit 180 is connected to the library unit 300 via a cable. The first and second communication units 170 and 180 are circuits that implement communication functions conforming, for example, to the Fiber Channel Standard, and are identified by their WWNs. The storage unit 140, the control unit 110, the first communication unit 170, and the second communication unit 180 are interconnected via a bus.

[Data storage apparatus: Storage unit] The storage unit 140 is, for example, a disk array comprising a collection of magnetic disks, or an SSD using a flash memory. [Hardware configuration of data storage apparatus] A detailed example of the hardware configuration of the data storage apparatus 100 will be described with reference to FIG. 3 and FIG. 4.

[Hardware configuration of data management unit] FIG. 3 is a diagram illustrating one example of the hardware configuration of the data management unit 200. The data management unit 200 illustrated in FIG. 3 includes a processing unit 212, a storage unit 222, a memory controller 226, a bus interface 228, a drive unit 232, an external storage unit 234, a first communication unit 170a, and a second communication unit 180a.

The processing unit 212 includes a processor core 214, an L2 cache (secondary cache) RAM (random access memory) 216, and an L2 cache controller which controls the L2 cache RAM 216. The processing unit 212 is connected to the storage unit 222 via the memory controller 226. The processing unit 212 is also connected to the drive unit 232, the external storage unit 234, the first communication unit 170a, and the second communication unit 180a via the bus interface 228.

The L2 cache RAM 216 temporarily stores some of the stored contents of the storage unit 222 in accordance with an instruction from the processor core 214. The L2 cache RAM 216 is, for example, a static random access memory (SRAM).

The processor core 214 reads data or an instruction from the L2 cache RAM 216, performs an operation on the data in accordance with the instruction, and stores the result of the operation in the L2 cache RAM 216 or in the storage unit 222. The instruction is stored in the form of a program 900 in the storage unit 222. The processing unit 212 may be implemented as a multi-core processor equipped with a plurality of processor cores 214. The processing unit 212 is, for example, a CPU.

By executing the program 900, the processing unit 212 operates as the control unit 110 illustrated in FIG. 2.

The memory controller 226 receives a load instruction from the processing unit 212 or the bus interface 228, loads data or an instruction from the storage unit 222, and transfers it to the processing unit 212 or the bus interface 228. Further, the memory controller 226 receives a store instruction and data to be stored from the processing unit 212 or the bus interface 228, and stores the received data in the storage unit 222.

The storage unit 222 is a storage device formed from a semiconductor device such as a DRAM.

The external storage unit 234 is a nonvolatile storage device, for example, a disk array comprising a collection of magnetic disks, or an SSD using a flash memory, that has a larger storage capacity than the storage unit 222 and that retains its stored contents after its power supply is removed. The external storage unit 234 may store the same instruction, data, and program as those stored in the storage unit 222.

The external storage unit 234 corresponds to the storage unit 140 illustrated in FIG. 2.

The bus interface 228 is a bus for connecting the processing unit 212 to other devices. The bus interface 228 is, for example, a circuit that functions in accordance with a standard such as AGP (Accelerated Graphics Port) or PCI Express (Peripheral Component Interconnect Express).

The drive unit 232 is a device for reading and writing data on a recording medium 236 such as a floppy (registered trademark) disk, CD-ROM, DVD (Digital Versatile Disc), etc. The drive unit 232 includes a motor for rotating the recording medium 236, a head for reading and writing data on the recording medium 236, etc. The program 900 may be stored on the recording medium 236. In that case, the drive unit 232 reads the program 900 from the recording medium 236 loaded into the drive unit 232. The program 900 read by the drive unit 232 is stored in the storage unit 222 and/or the external storage device 234 under control of the processing unit 212.

The first communication unit 170a and the second communication unit 180a correspond to the first communication unit 170 and the second communication unit 180, respectively, illustrated in FIG. 2.

[Detailed hardware configuration of library unit] FIG. 4 is a diagram illustrating one example of the hardware configuration of the library unit. The library unit 300 illustrated in FIG. 4 includes a communication unit 310, a control unit 320, a medium drive 330, a robot unit 340, a load/unload mechanism 350, and a container cell 360.

The communication unit 310, which is connected to the data management unit 200 via a cable such as a fiber optic cable, receives write data from the data management unit 200 or transfers data received from the medium drive 330 to the data management unit 200. The communication unit 310 is a circuit that implements communication functions conforming, for example, to the Fiber Channel Standard, and is identified by its worldwide name (WWN).

The control unit 320 is connected to the communication unit 310, the medium drive 330, the robot unit 340, and the load/unload mechanism 350. The control unit 320 transfers the write data received from the communication unit 310 to the medium drive 330, or transfers the data read out of a recording medium by the medium drive 330 to the communication unit 310. Further, the control unit 320 instructs the robot unit 340 to withdraw a recording medium from the container cell 360 or store a recording medium into the container cell 360. The control unit 320 also issues an instruction to the load/unload mechanism 350 to load a recording medium placed thereon into the library unit or to unload a recording medium placed thereon outside the library unit.

The medium drive 330 includes a read-write head 332. The medium drive 330 receives from the control unit 320 the data to be written to the recording medium, and writes the data to the recording medium by means of the read-write head 332. Further, the medium drive 330 transfers the data read out of the recording medium by means of the read-write head 332 to the control unit 320. In FIG. 4, only one medium drive 330 is illustrated, but the library unit 300 may contain a plurality of medium drives 330. In that case, the plurality of medium drives 330 perform read/write operations independently of each other.

The robot unit 340 includes an identification information (ID) reader 342. Using the ID reader 342, the robot unit 340 identifies the identification information attached to the recording medium stored in the container cell 360 or placed on the load/unload mechanism 350. The ID reader 342 is, for example, a barcode reader, and the identification information attached to the recording medium is, for example, a barcode. The robot unit 340 locates the recording medium having the ID specified by the control unit 320, and transports the recording medium between the container cell 360 and the load/unload mechanism 350 or the medium drive 330 in accordance with an instruction from the control unit 320.

The load/unload mechanism 350 is a mechanism for loading a recording medium into the library and unloading a recording medium from the library. The recording medium loaded by the load/unload mechanism 350 is stored in the container cell 350 by means of the robot unit 340. The recording medium 380 to which exported data has been written is transported by the robot unit 340 from the medium drive 330 to the load/unload mechanism 350 for unloading outside the library unit 300.

The container cell 360 holds a plurality of recording media.

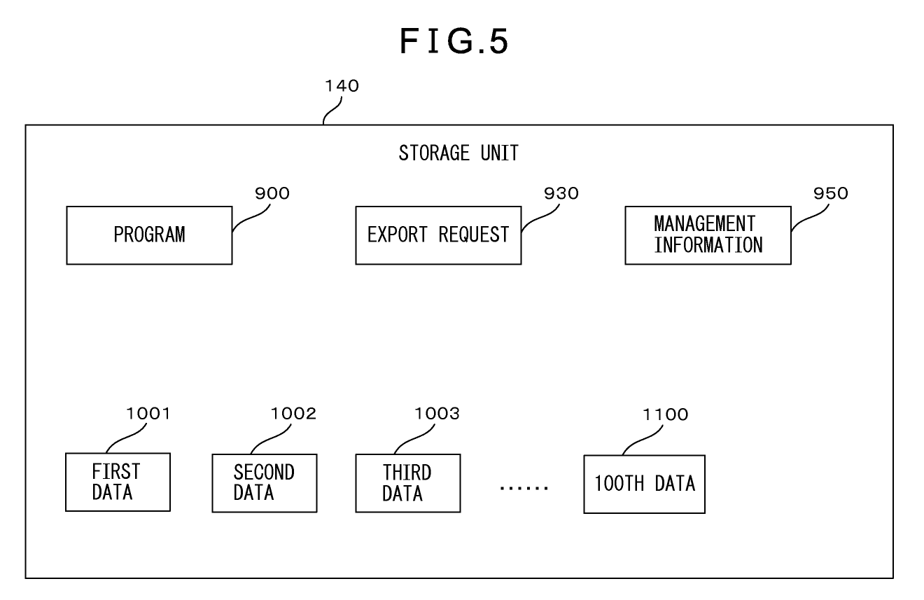

FIG. 5 is a diagram for explaining one example of data stored on the storage unit. The storage unit 140 stores the program 900, an export logical volume list 930 transmitted from the server 10, management information 950, and first to 100th data 1001 to 1100. The first to 100th data 1001 to 1100 are, for example, data as logical volumes. Here, the number of data stored on the storage unit 140 is not limited to the specific number illustrated in FIG. 5. The program 900 is executed by the control unit 110 to implement the prescribed functions of the control unit 110.

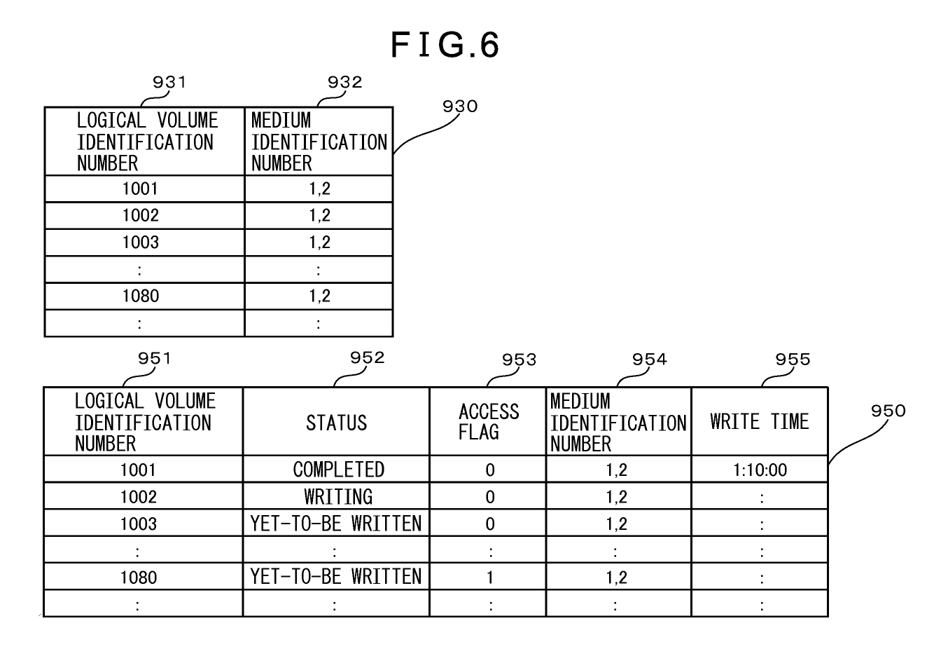

FIG. 6 is a diagram illustrating one example of the export logical volume list and data management information. The export logical volume list provides information for specifying the data to be exported and the recording medium to which the data is to be written. The data to be exported refers, for example, to the logical volume to be exported. As illustrated in the export logical volume list 930 of FIG. 6, the export logical volume list carries, for example, as many logical volume records as there are the logical volumes requested to be exported. Each record comprises values carried in a logical volume identification number column 931 and a medium identification number column 932. The export logical volume list 930 specifies that as many data as there are the logical volume records be written to the recording medium. The server 10 sends the export logical volume list 930 as an export request to the data storage apparatus 100.

In the logical volume identification number column 931, the identification numbers of the logical volumes to be exported are entered. In the example illustrated in FIG. 6, reference numerals designating the data 1001 to 1100 illustrated in FIG. 5 are entered in the logical volume identification number column 931. The export logical volume list 930 of FIG. 6 indicates that the export process may be performed, starting from the data specified by the smallest logical volume identification number and proceeding in ascending order of the logical volume identification numbers 931 illustrated in FIG. 6. The identification number assigned to the recording medium is entered in the medium identification number column 932. The identification number designates the export destination recording medium.

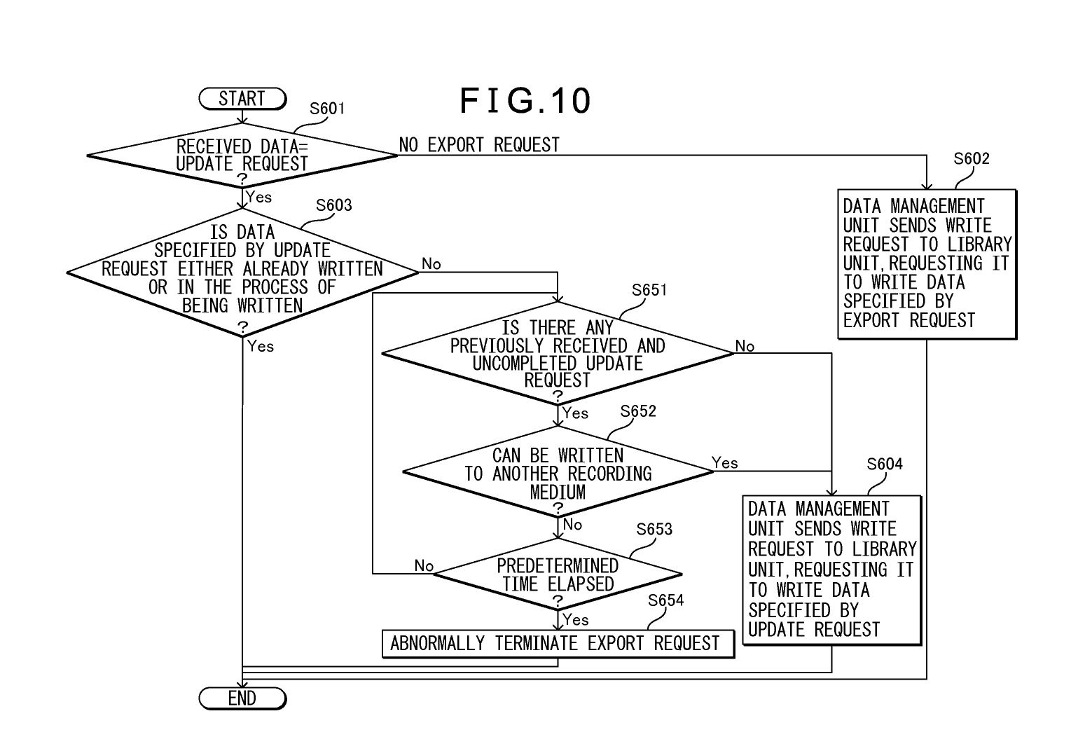

The server 10 specifies the identification number by creating the export logical volume list 930. The library unit 300 may locate the recording medium by using the identification number. As illustrated in FIG. 6, when the medium identification number is “1,2”, the server 10 specifies that the logical volume to be exported be written to the recording medium whose medium identification number is either “1” or “2”. Therefore, when the medium identification number is “1,2”, if the storage capacity of the recording medium designated by the identification number “1” has been used up during data writing, that is, if there is not enough storage capacity left to write the data to be exported, then the data is written to the recording medium designated by the identification number “2”. As will be described later with reference to FIG. 10, since the recording medium to which the data is to be written is designated by its identification number, the server 10 specifies the identification number of the export destination recording medium.

FIG. 6 also illustrates one example of the data management information. The management information 950 illustrated in FIG. 6 carries records on a logical volume by logical volume basis. Each record comprises values carried in a logical volume identification number column 951, a status column 952, an access flag column 953, a medium identification number column 954, and a write time column 955.

In the logical volume identification number column 951, the identification numbers of the logical volumes to be exported are entered. The identification numbers entered in the logical volume identification number column 951 correspond to the identification numbers carried in the export logical volume list 930. In the status column 952, the status of each record is entered, such as “completed”, “writing”, and “yet-to-be written” which indicates neither “completed” nor “writing”.

The access flag column 953 carries flag information “0” or “1” indicating whether an update request is received from the server 10 during the export process for the corresponding logical volume record. The flag information “0” indicates that there is no update request from the server 10 for the corresponding logical volume record. On the other hand, the flag information “1” indicates that there is an update request from the server 10 for the corresponding logical volume record. The example of FIG. 6 illustrates that an update request is received from the server 10 for the 80th data 1080. The medium identification number column 954 carries the identification number of the export destination recording medium. The identification number entered in the medium identification number column 954 corresponds to the identification number carried in the medium identification number column 932 of the export logical volume list 930. The write time 955 indicates the time at which the data was written to the recording medium.

[Data storage apparatus: Control unit] The control unit 110 implements the prescribed functions by executing the program 900 stored on the storage unit 140. The control unit 110 virtualizes the storage unit 140 so that it appears as the library unit 300 to the server 10. With this virtualization, the control unit 110 performs data management in which, for example, the data expected to be retrieved by the server 10 by trying to access the library unit 300 is stored on the storage unit 140, while on the other hand, the data stored on the storage unit 140 is transferred to the library unit 300 for storing on a recording medium. The data management is, for example, a process that uses the storage unit 140 as the first-generation backup and stores multiple-generation backup data in the library unit 300. To write the multiple-generation backup data to the recording media in addition to the export request, the control unit 110 performs a process called “archiving” by which the data stored on the storage unit 140 is written into the library unit 300. Further, similarly to the CPU 12 in the server 10, the control unit 110 may construct logical volumes using, for example, a plurality of magnetic disks and may manage the storage areas on the storage unit 140 and the library 300 by using the thus constructed logical volumes.

When the export request is received from the server 10, the control unit 110 performs processing to write the data specified by the export request to the external recording medium 380. That is, the plurality of logical volumes to be exported, stored on the storage unit 140, are collectively written to the external recording medium 380 under control of the control unit 110. If an update request for any data that is to be written later is received from the server 10 during the execution of the export request, the control unit 110 performs write-order control so that the data specified by the update request is written to the recording medium in the library unit 300 immediately after the data currently being written.

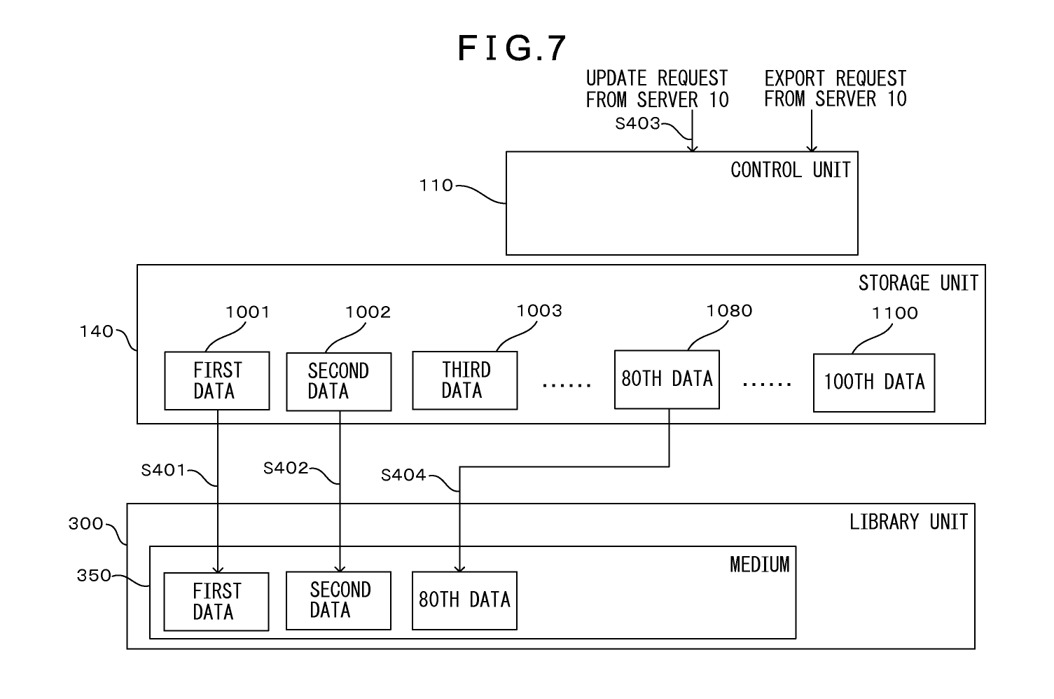

FIG. 7 is a diagram for explaining one example of how the write-order control is performed. When the export logical volume list 930 is received as the export request from the server 10, the control unit 110 writes the data stored on the storage unit 140 to the recording medium 380, starting from the first data 1001 (S401), then proceeding to the second data 1002 (S402), and so on, that is, in ascending order of the data.

When the second data 1002 is being written to the recording medium 380, if an update request for the 80th data 1080 scheduled to be exported later is received from the server 10 (S403) then the control unit 110 performs control so that the 80th data 1080, not the third data 1003 succeeding the second data 1002 currently being written, is written to the location on the recording medium 380 at which the third data 1003 would normally be written (S404). In the case of a recording medium such as a tape medium, data are sequentially written, but once the data retrieved from such a recording medium is stored on the storage unit 140, the stored data may be randomly accessed from the server 10; there is therefore no need to store the data in sequential order on the magnetic tape. Since the data need not be stored in sequential order on the magnetic tape, the logical volume originally scheduled to be written at a later time may be recorded on the magnetic tape at an earlier time.

Specifically, the control unit 100 controls, when performing processing to write a plurality of data including an optional first data (for example, data 1002) and an optional second data (for example, data 1080) from the storage unit 140 to the recording medium 380 in the library unit 300, if an update request for updating the optional second data (1080) specified to be written later than the optional first data (1002) is received from the information processing apparatus (server 10), the optional second data (1080) is written to the recording medium 380 in the library unit 300 before the optional first data (1002) is written. Therefore, the data (1080), which receives the update request output from the information processing apparatus, is written to the recording medium 380 before the data (1002) is written, while the data (1002) does not receive the update request.

In this way, if an update request for any data scheduled to be exported later is received during the export process, the control unit 110 preferentially writes the data specified by the update request to the recording medium 380, thereby reducing the time that the server 10 has to wait before a response to the update request is returned.

The control unit 110 refers to the management information 950 illustrated in FIG. 6 and writes the 80th data 1080 specified by the update request to the recording medium. The control unit 110 may check the status in the management information 950 maintained in the storage unit 140 and may perform control to write the data specified by the update request immediately after the data whose status indicates “writing”.

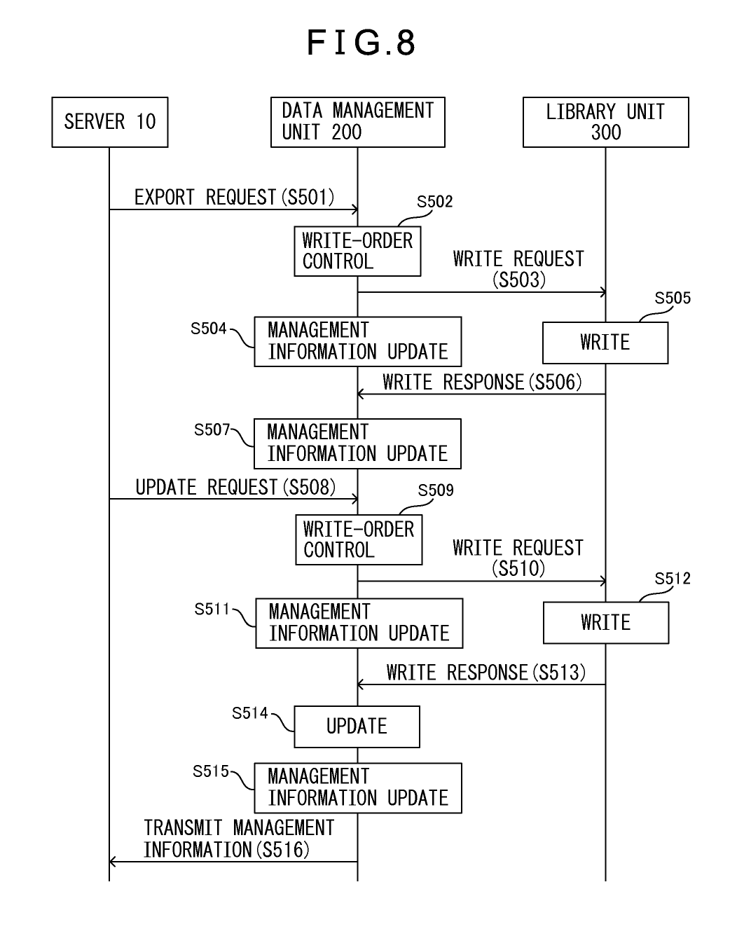

In FIG. 7, S401 is illustrated as being initiated by receiving the export request from the server 10 but, instead of the export request, the initiation of archiving may be used as the event for initiating S401. In that case, the export request is an archive request created for archiving.

[Data transmission between server and data storage apparatus] Data transmission between the server and the data storage apparatus will be described with reference to FIG. 8 to FIG. 10. [Data transmission between server and data storage apparatus: Sequence] FIG. 8 is a diagram illustrating one example of a sequence for data transmission between the server and the data storage apparatus. The sequence diagram of FIG. 8 illustrates the data transmission between the server 10, the data management unit 200, and the library unit 300 to clarify the data transmission between the data management unit 200 and the library unit 300 in the data storage apparatus 100.

The server 10 transmits the export logical volume list 930 to the data management unit 200 (S501). The export logical volume list 930 is, for example, the same as the export logical volume list 930 described with reference to FIG. 6. Here, instead of the export request received from the server 10, the initiation of archiving may be used as the event for initiating S501. In that case, the export request 930 is an archive request created for archiving.

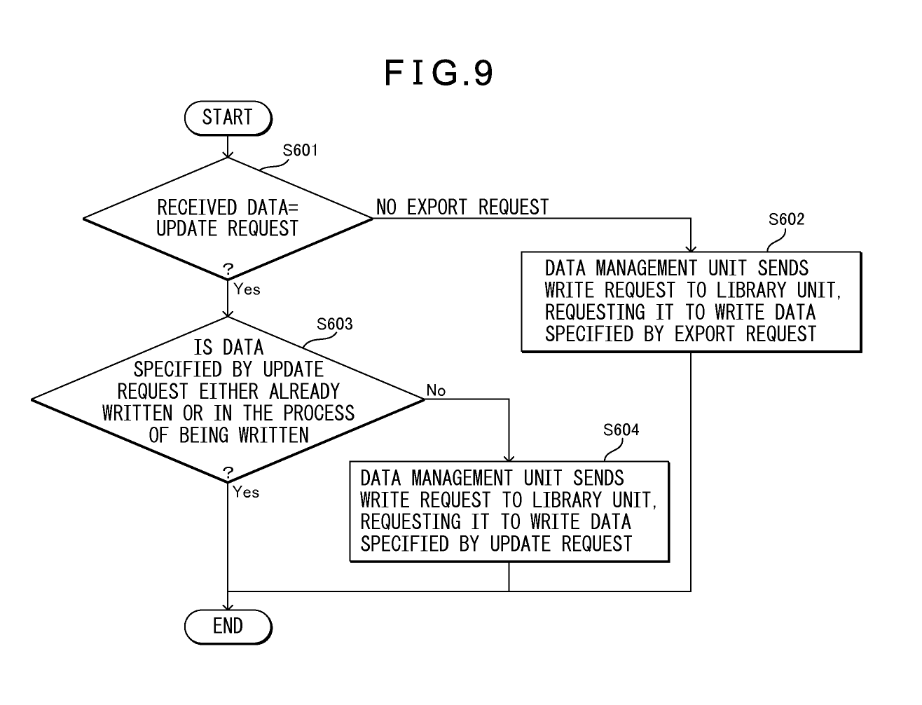

The data management unit 200 performs the write-order control for the export target data in the order specified in the logical volume identification number column 931 of the export request (S502), and sends a write request to the library unit 300 to write the export target data to the recording medium (S503). The data to be exported are specified, for example, on a logical volume by logical volume basis. The write-order control performed in S502 and S509 (to be described later) by the data management unit 200 will be described later with reference to FIG. 9 and FIG. 10.

After sending the write request to the library unit 300, the data management unit 200 changes the status of the record from “yet-to-be written” to “writing” (S504).

The library unit 300 writes the data specified by the write request to the recording medium (S505), and sends a write response to the data management unit 200 to notify that the writing is completed (S506). When the write response is received from the library unit 300, the data management unit 200 changes the status of the record in the management information 950 from “writing” to “completed” (S507). The process from S502 to S507 corresponds, for example, to the write process in S401 or S402 described with reference to FIG. 7.

The server 10 transmits an update request for one particular data stored on the storage unit 160 (S508). The update request here is, for example, a request for updating a particular logical volume in the export logical volume list 930 that the server 10 makes during the execution of the export process initiated by the export request. The data management unit 200 checks the status in the management information 950 to see whether the writing of that particular logical volume designated in the export logical volume list 930 received from the server 10 is completed or not; if the writing is completed, the corresponding data stored on the storage unit 160 is updated (S509) in accordance with the update request (S508). On the other hand, if the writing of the data specified by the update request is not yet completed, the data management unit 200 sends to the library unit 300 a write request for writing the data specified by the update request to the recording medium (S510). After sending the write request to the library unit 300, the data management unit 200 changes the status of that record from “yet-to-be written” to “writing” (S511). The library unit 300 writes the data specified by the write request (S512), and sends a write response to the data management unit 200 to notify that the writing is completed (S513). When the write response is received from the library unit 300, which notifies that the writing of the data specified by the update request is completed, the data management unit 200 in response to the update request (S508) updates that particular data stored on the storage unit 140 by the data transmitted from the server (S514). The data management unit 200 changes the status of the corresponding record in the management information 950 from “writing” to “completed” (S515). The process from 5508 to 5515 corresponds, for example, to the process in 5403 and 5404 described with reference to FIG. 7.

The data management unit 200 transmits the updated management information 950 to the server 10 (S516). The access flag column 953 in the management information 950 received by the server 10 indicates which data has been accessed from the server 10 during the export process. Accordingly, by receiving the management information 950, the server 10 may identify which data has been updated during the export process, and may therefore take measures, for example, not to update the thus updated logical volume during the next export process.

[Data transmission between server and data storage apparatus: First example of write-order control process flow] FIG. 9 is a flowchart illustrating a first example of the write-order control process flow. When data is received from the server 10, the data management unit 200 checks the received data whether it is an export request or an update request (S601). If the received data is an export request (No in S601), the data management unit 200 sends a write request to the library unit 300, requesting it to write the data specified by the export request to the export destination recording medium (S602), after which the write-order control is terminated.

If the received data is an update request (Yes in S601), the data management unit 200 checks to see whether the data specified by the update request is either already written to the recording medium or in the process of being written (S603). This decision may be made by checking whether the status of the corresponding record in the management information 950 is either “completed” or “writing”. If the status of the data specified by the update request is neither “completed” nor “writing” (No in S603), the data management unit 200 sends a write request to the library unit 300, requesting it to write the data specified by the update request to the recording medium (S604), after which the write-order control is terminated. If the status of the data specified by the update request is “completed” or “writing” (Yes in S603), the data management unit 200 terminates the write-order control.

[Data transmission between server and data storage apparatus: Second example of write-order control process flow] While the example illustrated in FIG. 8 has been described for the case where an update request for one particular data is received during the export process, the request for updating may be made for a plurality of data. However, if the number of update requests increases, the waiting time of the server 10 associated with such update requests may increase even if the write-order control is performed. To address this, the following process flow may be performed as an alternative to the write-order control illustrated in FIG. 9.

FIG. 10 is a flowchart illustrating a second example of the write-order control process flow. The process from S601 to S604 in FIG. 10 is the same as the process from S601 to S604 in FIG. 9, and therefore, will not be described here.

If the data specified by the update request is not yet written or not in the process of being written (No in S603), the data management unit 200 checks to see in S651 if there is any uncompleted update request received prior to the reception of the update request in S601. The data management unit 200 may make the decision in S651 by referring, for example, to the management information 950 and checking if there is any record whose access flag is set to “1” but whose status is not set to “completed”. If there is no such previously received and uncompleted update request (No in S651), the data management unit 200 sends a write request to the library unit 300, requesting it to write the data specified by the update request (S604), after which the write-order control is terminated. If there is a previously received and uncompleted update request (Yes in S651), then the data management unit 200 determines whether the logical volume specified by the previously received and uncompleted update request may be written to a recording medium other than the export destination recording medium (S652). Here, if the medium identification number column 954 carries a plurality of medium identification numbers, the data management unit 200 may determine whether the logical volume may be written to the recording medium loaded in the medium drive 330 (FIG. 4) that is not currently operating or is not expected to be used to process any previous write request. Here, the medium drive 330 may send its operating/non-operating status to the control unit 320, and the control unit 320 may pass that status to the data management unit 200, thus enabling the data management unit 200 to detect whether the medium drive 330 is currently operating or not. Further, if there is a medium identification number associated with the medium drive 330, the data management unit 200 may determine whether the medium drive is expected to be used, by checking the medium identification number carried in the medium identification number column 932 of the export logical volume list 930.

If the logical volume may be written to such other recording medium (Yes in S652), the data management unit 200 sends a write request to the library unit 300 by specifying the designated medium drive 330 and the recording medium that may be used for writing (S604), after which the write-order control is terminated.

If the logical volume may not be written to any other recording medium (No in S652), the data management unit 200 determines whether a predetermined time has elapsed, for example, from the time that the update request was received from the server 10. If the predetermined time has not yet elapsed (No in S653), the data management unit 200 returns to 5651 to repeat the above process. On the other hand, if the predetermined time has elapsed (Yes in S653), the data management unit 200 abnormally terminates the export request and transmits the result of the abnormal termination to the server 10, after which the write-order control is terminated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A data storage apparatus, connected to an information processing apparatus, the data storage apparatus comprising:
a library unit;
a storage unit configured to store a plurality of data including first and second data received from the information processing apparatus; and
a control unit configured to perform control, when performing processing to write the plurality of data from the storage unit to a recording medium in the library unit, if an update request for updating the second data specified to be written later than the first data is received from the information processing apparatus, the second data is written to the recording medium in the library unit before the first data is written.

2. The data storage apparatus as claimed in claim 1, wherein,
when the update request is received, the control unit sends a notification of a reception of the update request to the information processing apparatus during or after writing of the data specified by the update request to the recording medium.

3. The data storage apparatus as claimed in claim 1, wherein
the library unit includes a first recording medium and a second recording medium,
the control unit performs control, if the update request for the second data is received from the information processing apparatus when the first data is in the process of being written to the first recording medium, the second data is written to the second recording medium.

4. A data management apparatus connected to an information processing apparatus and a library apparatus including a recording medium, the data management apparatus comprising:
a storage unit; and
a control unit configured to perform control, when performing processing to write a plurality of data from the storage unit to the recording medium in the library apparatus, if an update request for updating second data specified to be written later than first data is received from the information processing apparatus, the second data is written to the recording medium in the library apparatus before the first data is written.

5. The data management apparatus as claimed in claim 4, wherein
when the update request is received, the control unit sends a notification of a reception of the update request to the information processing apparatus during or after writing of the data specified by the update request to the recording medium.

6. The data management apparatus as claimed in claim 4, wherein
the library apparatus includes a first recording medium and a second recording medium, and
the control unit performs control, if the update request for the second data is received from the information processing apparatus when the first data is in the process of being written to the first recording medium, the second data is written to the second recording medium.

7. A control method for use in a data management apparatus connected to an information processing apparatus and a library apparatus including a recording medium, the control method comprising:
initiating processing to write a plurality of data stored on the storage unit to the recording medium contained in the library apparatus; and
performing control, if an update request for updating second data specified to be written later than first data is received from the information processing apparatus during the write processing, the second data is written to the recording medium before the first data is written.

8. The control method as claimed in claim 7, the control method further comprising:
sending a notification of a reception of the update request to the information processing apparatus during or after writing of the second data to the recording medium.

9. The control method as claimed in claim 7, wherein the library apparatus includes a first recording medium and a second recording medium, and the control method further comprises:
performing control, if the update request for the second data is received from the information processing apparatus when the first data is in the process of being written to the first recording medium, the second data is written to the second recording medium in the library apparatus.
